(19) United States
(12) Patent Application Publication
(10) Pub. No.: US 2025/0084312 A1
(43) Pub. Date: Mar. 13, 2025

(54) METHOD FOR IMPROVING ALKALINE SOIL AND ENHANCING CARBON CAPTURE USING SLUDGE STABILIZATION PRODUCT

(71) Applicant: TONGJI UNIVERSITY, Shanghai (CN)

(72) Inventors: Bin DONG, Shanghai (CN); Sisi CHEN, Shanghai (CN); Jun GAO, Shanghai (CN); Zuxin XU, Shanghai (CN)

(21) Appl. No.: 18/288,122

(22) PCT Filed: May 18, 2023
(86) PCT No.: PCT/CN2023/094963

§ 371 Date: Oct. 24, 2023

(30) Foreign Application Priority Data
May 18, 2022 (CN) 202210544289.8

(51) Int. Cl. C09K 17/50

(52) U.S. Cl. CPC C09K 17/50

(57) ABSTRACT

Disclosed is a method for improving alkaline soil and enhancing carbon capture using a sludge stabilization product. The method includes the following steps: subjecting sludge to aerobic composting to obtain a stabilized product A; subjecting one part of the stabilized product A to extraction to obtain humus B; subjecting the other part of the stabilized product A to hydrothermal extraction to obtain a soluble organic matter rich in amino acids and organic salts, and conducting evaporation to dryness to obtain a mixture C; subjecting a residue obtained during the extraction of the humus B and the mixture C to pyrolysis to obtain biochar D rich in metal oxides; mixing the stabilized product A, the humus B, the mixture C, and the biochar D fully to obtain a soil amendment E; and applying the soil amendment E to a surface layer of alkaline soil, and then cultivating a plant.

### CROSS REFERENCE TO RELATED APPLICATION

The present application claims priority to the Chinese Patent Application No. CN202210544289.8, filed with the China National Intellectual Property Administration (CNIPA) on May 18, 2022, and entitled “METHOD FOR IMPROVING ALKALINE SOIL AND ENHANCING CARBON CAPTURE USING SLUDGE STABILIZATION PRODUCT”, which is incorporated herein by reference in its entirety.

### TECHNICAL FIELD

The present disclosure relates to the field of soil amendment, in particular to a method for improving alkaline soil and enhancing carbon capture using a sludge stabilization product.

### BACKGROUND

Carbon capture and sequestration (CCS) refers to a technology that collects carbon dioxide (CO₂) produced by large power plants and stores in various approaches to prevent from its release into atmosphere. This technology is considered to be the most economical and feasible way to reduce greenhouse gas emissions and slow down global warming on a large scale in the future.

CO₂ concentration in the air can be reduced through negative emission technologies such as bioenergy with carbon capture and storage (BECCS), afforestation, enhanced weathering, biochar formation, ocean enrichment, and soil carbon sequestration. However, each of these technologies carries different inherent risks. For example, the BECCS and afforestation on a large scale may require a large amount of land and then threaten biodiversity; the enhanced weathering has the potential to cause changes in pH and chemical composition of the rivers and oceans.

Saline-alkali soil plays an important role in the capture of carbon dioxide from the air. However, the saline-alkali soil is facing more serious problems such as water and soil loss, vegetation destruction, and ecological imbalance. This type of soil is highly alkaline and barren, making it difficult for plants to grow. Therefore, there is a need to remediate saline-alkali soil without disturbing, or even enhancing its carbon capture capacity instead.

### SUMMARY

In order to overcome the defects in the prior art, an objective of the present disclosure is to provide a method for improving alkaline soil and enhancing carbon capture using a sludge stabilization product. The method can simultaneously realize sludge resource utilization, alkaline soil amendment, and enhanced carbon capture. The method shows no secondary pollution, avoids water and soil loss, and has a long-lasting carbon capture function.

To achieve the above objective, the present disclosure provides the following technical solutions:

The present disclosure provides a method for improving alkaline soil and enhancing carbon capture using a sludge stabilization product, including the following steps:
(1) subjecting sludge to aerobic composting to obtain a stabilized product A;
(2) subjecting one part of the stabilized product A to extraction to obtain humus B; subjecting the other part of the stabilized product A to hydrothermal extraction to obtain a soluble organic matter rich in amino acids and organic salts, and conducting evaporation to dryness to obtain a mixture C;
(3) subjecting a residue obtained during the extraction of the humus B and the mixture C to pyrolysis to obtain biochar D rich in metal oxides;
(4) mixing the stabilized product A, the humus B, the mixture C, and the biochar D fully to obtain a soil amendment E; and
(5) applying the soil amendment E to a surface layer of alkaline soil, mixing the soil amendment E with alkaline soil 0 cm to 30 cm under the surface layer in a rolling-over manner, conducting sprinkler irrigation to keep a field capacity of 40% to 50% by weight per weight (w/w), and then cultivating a plant.

Preferably, the sludge is dewatered sludge or dried sludge with a water content of 50% to 70% (w/w), a pH value of 6 to 8, an organic matter having a mass content accounting for 40 to 60% of a sludge dry basis, an organic nitrogen content of 40 mg/g to 50 mg/g of the sludge dry basis, an organic carbon content of 300 mg/g to 350 mg/g of the sludge dry basis, an iron content of 20 mg/g to 50 mg/g, an aluminum content of 20 mg/g to 50 mg/g, and a magnesium content of 5 mg/g to 10 mg/g.

Preferably, an auxiliary material with a mass ratio of 20% to 40% of a dry weight of the sludge is added during the aerobic composting, and the auxiliary material is selected from the group consisting of straw and rice husk; and the aerobic composting is conducted at 50° C. to 60° C. or 70° C. to 80° C. for 20 d to 30 d.

Preferably, the stabilized product A has a water content of 30% to 50% (w/w), an organic matter having a mass content accounting for 30% to 40% of a dry basis, a pH value of 6 to 8, an organic nitrogen content of 25 mg/g to 40 mg/g of the dry basis, and an organic carbon content of 200 mg/g to 300 mg/g of the dry basis.

Preferably, a process of extracting the humus B includes: in parts by mass, mixing 1 part of the dried sludge with 50 parts of an extract liquor to allow shaking for 48 h, conducting filtration to obtain a supernatant, and subjecting the supernatant to evaporation to dryness to obtain the humus B; where the extract liquor includes 0.1 mol/L of Na₄P₂O₇ and 0.1 mol/L of NaOH; and
the humus B has an organic carbon content of 300 mg/g to 400 mg/g of a dry basis and a cation exchange rate of 60 cmol/kg to 80 cmol/kg of the dry basis.

Preferably, a process of extracting the mixture C includes: diluting the stabilized product A with water to a water content of 8% to 12% (w/w), conducting hydrothermal treatment at 120° C. to 160° C. for 10 min to 30 min, cooling, conducting filter pressing to obtain the soluble organic matter rich in amino acids and organic salts, and conducting evaporation to dryness to obtain the mixture C; where
the mixture C has a chemical oxygen demand (COD) of 8,000 mg/g to 10,000 mg/g of a dry basis, an amino acid content of 80 mg/g to 100 mg/g of the dry basis, and an electrical conductivity of 5 ds/m to 10 ds/m.

Preferably, the pyrolysis is conducted at 600° C. to 800° C. under an inert atmosphere including nitrogen or argon as a carrier gas at a gas flow rate of 100 mL/min to 200 mL/min for 30 min to 60 min; a pyrolysis program starts from a room temperature by heating at 8° C./min to 20° C./min, and then terminates by cooling gradually to the room temperature at 10° C./min to 30° C./min; and
the biochar D has a specific surface area of 800 m²/g to 1,200 m²/g, includes oxides of iron, magnesium, and aluminum, and has an iron content of 50 mg/g to 80 mg/g, an aluminum content of 50 mg/g to 80 mg/g, and a magnesium content of 10 mg/g to 20 mg/g.

Preferably, the stabilized product A, the humus B, the mixture C, and the biochar D are mixed at a mass ratio of (5-10):1:1:1.

Preferably, the soil amendment E is applied to the surface layer of the alkaline soil at (50-100) kg by dry basis/square meter of the alkaline soil; and the plant is selected from the group consisting of Populus, Tamarix chinensis, and Elaeagnus angustifolia.

Preferably, an organic carbon content of the alkaline soil 0 cm to 30 cm under the surface layer mixed with the soil amendment E has an increase of (2-5) kg/square meter of the alkaline soil.

As an inevitable by-product of sewage treatment, sludge is rich in organic matters, nitrogen, phosphorus, humus and other substances. Therefore, sludge can be used as an important substrate for plant growth to remediate saline-alkali soil. Sludge is rich in organic polymers and salts that absorb carbon dioxide from the air. The remediated saline-alkali soil can grow plants and absorb carbon dioxide through photosynthesis, thus achieving the function of enhancing carbon capture.

In the present disclosure, functional substances in the sludge stabilization product are classified and extracted to obtain humus B and mixture C containing amino acids and organic salts. The humus B can further induce the soluble organic carbon (such as aliphatic compounds) in the soil to aggregate into difficult-to-use macromolecular substances under the action of microorganisms, thereby trapping and sequestering the carbon in the soil. The mixture C containing amino acids and organic salts can conduct strong chemical absorption and capture of carbon dioxide in the air under alkaline conditions. The carbon dioxide and metal ions such as calcium and magnesium in alkaline soil generate alkali metal ion carbonate for sequestration. Since the main nitrogen-containing organic matter in the sludge is removed, the residue obtained during the extraction of humus B and mixture C greatly reduces the generation of harmful by-products such as NH₃ and HCN during the pyrolysis. Moreover, the obtained biochar D is rich in iron, magnesium, aluminum and other metal oxides, which can physically absorb and capture carbon dioxide in the air and soluble organic carbon in the soil, to facilitate the carbon sequestration by metal oxides. Mixing the stabilized product A with functional substances extracted from the stabilized product A in a specific ratio can further strengthen carbon capture and sequestration in addition to meeting the needs of plant growth substrates to amend soil, prevent water and soil loss, and contribute to carbon capture through photosynthesis.

In the present disclosure, a key step is to classify and extract the functional substances in the sludge stabilization product. One part is used to extract humus B, and the other part is used to extract mixture C containing soluble amino acids and organic salts. The extraction can enrich functional substances and remove other unwanted impurities. Compared with the direct application of sludge, the method of the present disclosure is not interfered by the cross-linking of other substances, and has higher carbon capture function.

In the present disclosure, instead of directly pyrolyzing the stabilized product to produce biochar, the residue obtained in extracting the humus B and mixture C is pyrolyzed. Since the main nitrogen-containing organic matter is removed in the early extraction, the generation of harmful by-products such as NH₃ and HCN is greatly reduced in the pyrolysis. Moreover, the obtained biochar D is rich in iron, magnesium, aluminum and other metal oxides, making the pyrolysis more sustainable.

In the present disclosure, a mixing ratio of the stabilized product A, humus B, mixture C and biochar D in step (4) is a key parameter affecting the soil amendment E. If a content of stabilized product A is too high, the carbon capture effect may be mediocre; if the content of stabilized product A is too low, the alkaline soil cannot be modified and regreened.

In the present disclosure, the application amount of the soil amendment E in the alkaline soil in step (5) is a key parameter affecting the remediation effect and carbon capture intensity of alkaline soil. If the application amount of the soil amendment E is too high, the cost may be too high and the carbon capture function of the alkaline soil itself may be reduced; if the application amount is too low, the alkaline soil cannot be effectively repaired.

Compared with the prior art, the present disclosure has the following advantages:

(1) In the preparation method of the alkaline soil amendment provided by the present disclosure, the soil amendment E can strengthen a carbon capture effect while having a function of soil remediation. The functional substances in the sludge stabilization product are classified and extracted. One part is used to extract humus, and the other part is used to extract soluble amino acids and organic salts. The extraction can enrich functional substances and remove other unwanted impurities. Compared with the direct application of sludge, the method is not interfered by the cross-linking of other substances, and has a higher carbon capture function.

(2) In the present disclosure, the stabilized product A strengthens the physical, chemical, and biological functions in carbon capture while remediating the soil. The humus B can further induce the soluble organic carbon (such as aliphatic compounds) in the soil to aggregate into difficult-to-use macromolecular substances under the action of microorganisms, thereby trapping and sequestering the carbon in the soil. The mixture C containing amino acids and organic salts can conduct strong chemical absorption and capture of carbon dioxide in the air under alkaline conditions. The carbon dioxide and metal ions such as calcium and magnesium in alkaline soil generate alkali metal ion carbonate for sequestration. The biochar D is rich in metal oxides such as iron, magnesium, and aluminum, and can physically absorb and capture carbon dioxide in the air and soluble organic carbon in the soil, which are convenient for the sequestration of metal oxides. The stabilized product A is mixed with functional substances in a specific ratio, and can further strengthen carbon capture and sequestration in addition to meeting the needs of plant growth substrates to amend soil, prevent water and soil loss, and contribute to carbon capture through photosynthesis.

### DETAILED DESCRIPTION OF THE EMBODIMENTS

The examples of the present disclosure will be described in detail below. The examples are implemented on the premise of the technical solution of the present disclosure, and detailed implementation and specific operation procedures are provided, but the protection scope of the present disclosure is not limited to the following examples.

The present disclosure provides a method for improving alkaline soil and enhancing carbon capture using a sludge stabilization product, including the following steps:

(1) subjecting sludge to aerobic composting for 20 d to 30 d to obtain a stabilized product A; where the sludge is dewatered sludge or dried sludge with a water content of 50% to 70% (w/w), a pH value of 6 to 8, an organic matter having a mass content accounting for 40 to 60% of a sludge dry basis, an organic nitrogen content of 40 mg/g to 50 mg/g of the sludge dry basis, an organic carbon content of 300 mg/g to 350 mg/g of the sludge dry basis, an iron content of 20 mg/g to 50 mg/g, an aluminum content of 20 mg/g to 50 mg/g, and a magnesium content of 5 mg/g to 10 mg/g; an auxiliary material with a mass ratio of 20% to 40% of a dry weight of the sludge is added during the aerobic composting, and the auxiliary material is selected from the group consisting of straw and rice husk; and the aerobic composting is conducted at 50° C. to 60° C. or 70° C. to 80° C. for 20 d to 30 d. The stabilized product A has a water content of 30% to 50% (w/w), an organic matter having a content accounting for 30% to 40% of a dry basis, a pH value of 6 to 8, an organic nitrogen content of 25 mg/g to 40 mg/g of the dry basis, and an organic carbon content of 200 mg/g to 300 mg/g of the dry basis.

(2) subjecting one part of the stabilized product A to extraction to obtain humus B; subjecting the other part of the stabilized product A to hydrothermal extraction to obtain a soluble organic matter rich in amino acids and organic salts, and conducting evaporation to dryness to obtain a mixture C; where a process of extracting the humus B includes: in parts by mass, mixing 1 part of the dried sludge with 50 parts of an extract liquor to allow shaking for 48 h, conducting filtration to obtain a supernatant, and subjecting the supernatant to evaporation to dryness to obtain the humus B; where the extract liquor includes 0.1 mol/L of Na₄P₂O₇ and 0.1 mol/L of NaOH; and the humus B has an organic carbon content of 300 mg/g to 400 mg/g of a dry basis and a cation exchange rate of 60 cmol/kg to 80 cmol/kg of the dry basis. A process of extracting the mixture C includes: diluting the stabilized product A with water to a water content of 8% to 12% (w/w), conducting hydrothermal treatment at 120° C. to 160° C. for 10 min to 30 min, cooling, conducting filter pressing to obtain the soluble organic matter rich in amino acids and organic salts, and conducting evaporation to dryness to obtain the mixture C; where the mixture C has a chemical oxygen demand (COD) of 8,000 mg/g to 10,000 mg/g of a dry basis, an amino acid content of 80 mg/g to 100 mg/g of the dry basis, and an electrical conductivity of 5 ds/m to 10 ds/m.

(3) subjecting a residue obtained during the extraction of the humus B and the mixture C to pyrolysis to obtain biochar D rich in metal oxides; where the pyrolysis is conducted at 600° C. to 800° C. under an inert atmosphere including nitrogen or argon as a carrier gas at a gas flow rate of 100 mL/min to 200 mL/min for 30 min to 60 min; a pyrolysis program starts from a room temperature by heating at 8° C./min to 20° C./min, and then terminates by cooling gradually to the room temperature at 10° C./min to 30° C./min; and the biochar D has a specific surface area of 800 m²/g to 1,200 m²/g, includes oxides of iron, magnesium, and aluminum detected by XPS, and has an iron content of 50 mg/g to 80 mg/g, an aluminum content of 50 mg/g to 80 mg/g, and a magnesium content of 10 mg/g to 20 mg/g.

(4) mixing the stabilized product A, the humus B, the mixture C, and the biochar D ratio fully to obtain a soil amendment E; where the stabilized product A, the humus B, the mixture C, and the biochar D are mixed at a mass ratio of (5-10):1:1:1.

(5) applying the soil amendment E to a surface layer of alkaline soil, mixing the soil amendment E with alkaline soil 0 cm to 30 cm under the surface layer in a rolling-over manner, conducting sprinkler irrigation to keep a field capacity of 40% to 50%, and then cultivating a plant. The soil amendment E is applied to the surface layer of the alkaline soil at (50-100) kg by dry basis/square meter of the alkaline soil; and the plant includes but not limited to Populus, Tamarix chinensis, and Elaeagnus angustifolia. An organic carbon content of the alkaline soil 0 cm to 30 cm under the surface layer mixed with the soil amendment E has an increase of (2-5) kg/square meter of the alkaline soil.

### Example 1

A method for improving alkaline soil and enhancing carbon capture using a sludge stabilization product included the following steps:

(1) Dewatered sludge was selected, with a water content of 70% (w/w), a pH value of 8, an organic matter content of 60% of a sludge dry basis, an organic nitrogen content of 50 mg/g of the sludge dry basis, an organic carbon content of 350 mg/g of the sludge dry basis, an iron content of 50 mg/g, an aluminum content of 50 mg/g, and a magnesium content of 10 mg/g. The dewatered sludge was added with straw at 40% of a dry weight of the sludge, and subjected to aerobic composting at 70° C. to 80° C. for 30 d to obtain a stabilized product A. The stabilized product A had a water content of 50% (w/w), an organic matter content of 40% of a dry basis, a pH value of 8, an organic nitrogen content of 40 mg/g of the dry basis, and an organic carbon content of 300 mg/g of the dry basis.

(2) The stabilized product A was divided into 2 parts. 1 part was used to extract humus B; and the other 1 part was used to extract a soluble organic matter rich in amino acids and organic salts through hydrothermal extraction, and a mixture C is obtained after evaporation to dryness. The extraction of humus B included: 1 part of dried sludge was mixed with 50 parts of an extract liquor to allow shaking for 48 h, filtered to obtain a supernatant, and the supernatant was evaporated to dryness to obtain the humus B, where the extract liquor included 0.1 mol/L Na₄P₂O₇ and 0.1 mol/L NaOH. The extraction of the mixture C included: the stabilized product A was diluted with water to a water content of 12%, subjected to hydrothermal treatment at 160° C. for 30 min, cooled, and filter-pressed to obtain a soluble organic matter rich in amino acids and organic salts, and evaporated to dryness to obtain the mixture C. The humus B had an organic carbon content of 400 mg/g of a dry basis, and a cation exchange rate of 80 cmol/kg of the dry basis. The mixture C had a COD of 10,000 mg/g of a dry basis, an amino acid content of 100 mg/g of the dry basis, and an electrical conductivity of 10 ds/m.

(3) A residue obtained during the extraction of the humus B and the mixture C was subjected to pyrolysis to obtain biochar D rich in metal oxides; where the pyrolysis was conducted at 800° C. under an inert atmosphere including nitrogen or argon as a carrier gas at a gas flow rate of 200 mL/min for 60 min; a pyrolysis program started from a room temperature by heating at 20° C./min, and then terminated by cooling gradually to the room temperature at 30° C./min; and the biochar D had a specific surface area of 1,200 m²/g, included oxides of iron, magnesium, and aluminum detected by XPS, and showed an iron content of 80 mg/g, an aluminum content of 80 mg/g, and a magnesium content of 20 mg/g.

(4) The stabilized product A, the humus B, the mixture C, and the biochar D fully at a mass ratio of 5:1:1:1 to obtain a soil amendment E.

(5) The soil amendment E was applied to a surface layer of alkaline soil at 100 kg by dry basis/square meter of the alkaline soil, mixed the soil amendment E with alkaline soil 0 cm to 30 cm under the surface layer in a rolling-over manner, sprinkler irrigation was conducted to keep a field capacity of 40% to 50%, and then a plant was cultivated. In the subsequent maintenance, an organic carbon content of the 0 cm to 30 cm in the surface layer of the alkaline soil after amendment had an increase of 5 kg/square meter of the alkaline soil.

### Comparative Example 1

This comparative example differed from the example in that: the residue obtained in extracting humus B and mixture C was replaced by the stabilized product A of corresponding mass; the stabilized product A was directly pyrolyzed to produce biochar, and the obtained biochar D had a specific surface area of 500 m²/g; the NH₃ and the HCN had a concentration of 30% higher than those of the example in the pyrolysis; and the organic carbon content of the 0 cm to 30 cm in the surface layer of the alkaline soil after amendment had an increase of 1.2 kg/square meter of the alkaline soil.

The above described are merely preferred embodiments of the present disclosure, which are not intended to limit the present disclosure in other forms. Any person skilled in the art may change or modify the technical content disclosed above into an equivalent. Any simple amendments or equivalent changes and modifications made to the above embodiments according to the technical essence of the present disclosure without departing from the content of the technical solution of the present disclosure should fall within the protection scope of the technical solution of the present disclosure.

1. A method for improving alkaline soil and enhancing carbon capture using a sludge stabilization product, comprising the following steps:
(1) subjecting sludge to aerobic composting to obtain a stabilized product A;
(2) subjecting one part of the stabilized product A to extraction to obtain humus B; subjecting the other part of the stabilized product A to hydrothermal extraction to obtain a soluble organic matter rich in amino acids and organic salts, and conducting evaporation to dryness to obtain a mixture C;
(3) subjecting a residue obtained during the extraction of the humus B and the mixture C to pyrolysis to obtain biochar D rich in metal oxides;
(4) mixing the stabilized product A, the humus B, the mixture C, and the biochar D fully to obtain a soil amendment E; and
(5) applying the soil amendment E to a surface layer of alkaline soil, mixing the soil amendment E with alkaline soil 0 cm to 30 cm under the surface layer in a rolling-over manner, conducting sprinkler irrigation to keep a field capacity of 40% to 50% by weight per weight (w/w), and then cultivating a plant.

2. The method according to claim 1, wherein the sludge is dewatered sludge or dried sludge with a water content of 50% to 70% (w/w), a pH value of 6 to 8, an organic matter having a mass content accounting for 40 to 60% of a sludge dry basis, an organic nitrogen content of 40 mg/g to 50 mg/g of the sludge dry basis, an organic carbon content of 300 mg/g to 350 mg/g of the sludge dry basis, an iron content of 20 mg/g to 50 mg/g, an aluminum content of 20 mg/g to 50 mg/g, and a magnesium content of 5 mg/g to 10 mg/g.

3. The method according to claim 1, wherein an auxiliary material with a mass ratio of 20% to 40% of a dry weight of the sludge is added during the aerobic composting, and the auxiliary material is selected from the group consisting of straw and rice husk; and the aerobic composting is conducted at 50° C. to 60° C. or 70° C. to 80° C. for 20 d to 30 d.

4. The method according to claim 1, wherein the stabilized product A has a water content of 30% to 50% (w/w), an organic matter having a mass content accounting for 30% to 40% of a dry basis, a pH value of 6 to 8, an organic nitrogen content of 25 mg/g to 40 mg/g of the dry basis, and an organic carbon content of 200 mg/g to 300 mg/g of the dry basis.

5. The method according to claim 1, wherein a process of extracting the humus B comprises: in parts by mass, mixing 1 part of the stabilized product A with 50 parts of an extract liquor to allow shaking for 48 h, conducting filtration to obtain a supernatant, and subjecting the supernatant to evaporation to dryness to obtain the humus B; wherein the extract liquor comprises 0.1 mol/L of Na₄P₂O₇ and 0.1 mol/L of NaOH; and
the humus B has an organic carbon content of 300 mg/g to 400 mg/g of a dry basis and a cation exchange rate of 60 cmol/kg to 80 cmol/kg of the dry basis.

6. The method according to claim 1, wherein a process of extracting the mixture C comprises: diluting the stabilized product A with water to a water content of 8% to 12% (w/w), conducting hydrothermal treatment at 120° C. to 160° C. for 10 min to 30 min, cooling, conducting filter pressing to obtain the soluble organic matter rich in amino acids and organic salts, and conducting evaporation to dryness to obtain the mixture C; wherein
the mixture C has a chemical oxygen demand (COD) of 8,000 mg/g to 10,000 mg/g of a dry basis, an amino acid content of 80 mg/g to 100 mg/g of the dry basis, and an electrical conductivity of 5 ds/m to 10 ds/m.

7. The method according to claim 1, wherein the pyrolysis is conducted at 600° C. to 800° C. under an inert atmosphere comprising nitrogen or argon as a carrier gas at a gas flow rate of 100 mL/min to 200 mL/min for 30 min to 60 min; a pyrolysis program starts from a room temperature by heating at 8° C./min to 20° C./min, and then terminates by cooling gradually to the room temperature at 10° C./min to 30° C./min; and
the biochar D has a specific surface area of 800 m²/g to 1,200 m²/g, comprises oxides of iron, magnesium, and aluminum, and has an iron content of 50 mg/g to 80 mg/g, an aluminum content of 50 mg/g to 80 mg/g, and a magnesium content of 10 mg/g to 20 mg/g.

8. The method according to claim 1, wherein the stabilized product A, the humus B, the mixture C, and the biochar D are mixed at a mass ratio of (5-10):1:1:1.

9. The method according to claim 1, wherein the soil amendment E is applied to the surface layer of the alkaline soil at (50-100) kg by dry basis/square meter of the alkaline soil; and the plant is selected from the group consisting of Populus, Tamarix chinensis, and Elaeagnus angustifolia.

10. The method according to claim 1, wherein an organic carbon content of the alkaline soil 0 cm to 30 cm under the surface layer mixed with the soil amendment E has an increase of (2-5) kg/square meter of the alkaline soil.

11. A preparation method of a soil amendment, comprising the following steps:
(1) subjecting sludge to aerobic composting to obtain a stabilized product A;
(2) subjecting one part of the stabilized product A to extraction to obtain humus B; subjecting the other part of the stabilized product A to hydrothermal extraction to obtain a soluble organic matter rich in amino acids and organic salts, and conducting evaporation to dryness to obtain a mixture C;
(3) subjecting a residue obtained during the extraction of the humus B and the mixture C to pyrolysis to obtain biochar D rich in metal oxides; and
(4) mixing the stabilized product A, the humus B, the mixture C, and the biochar D fully to obtain a soil amendment E.

12. The preparation method according to claim 11, wherein the sludge is dewatered sludge or dried sludge with a water content of 50% to 70% (w/w), a pH value of 6 to 8, an organic matter having a mass content accounting for 40 to 60% of a sludge dry basis, an organic nitrogen content of 40 mg/g to 50 mg/g of the sludge dry basis, an organic carbon content of 300 mg/g to 350 mg/g of the sludge dry basis, an iron content of 20 mg/g to 50 mg/g, an aluminum content of 20 mg/g to 50 mg/g, and a magnesium content of 5 mg/g to 10 mg/g.

13. The preparation method according to claim 11, wherein an auxiliary material with a mass ratio of 20% to 40% of a dry weight of the sludge is added during the aerobic composting, and the auxiliary material is selected from the group consisting of straw and rice husk; and the aerobic composting is conducted at 50° C. to 60° C. or 70° C. to 80° C. for 20 d to 30 d.

14. The preparation method according to claim 11, wherein the stabilized product A has a water content of 30% to 50% (w/w), an organic matter having a mass content accounting for 30% to 40% of a dry basis, a pH value of 6 to 8, an organic nitrogen content of 25 mg/g to 40 mg/g of the dry basis, and an organic carbon content of 200 mg/g to 300 mg/g of the dry basis.

15. The preparation method according to claim 11, wherein a process of extracting the humus B comprises: in parts by mass, mixing 1 part of the stabilized product A with 50 parts of an extract liquor to allow shaking for 48 h, conducting filtration to obtain a supernatant, and subjecting the supernatant to evaporation to dryness to obtain the humus B; wherein the extract liquor comprises 0.1 mol/L of Na₄P₂O₇ and 0.1 mol/L of NaOH; and
the humus B has an organic carbon content of 300 mg/g to 400 mg/g of a dry basis and a cation exchange rate of 60 cmol/kg to 80 cmol/kg of the dry basis.

16. The preparation method according to claim 11, wherein a process of extracting the mixture C comprises: diluting the stabilized product A with water to a water content of 8% to 12% (w/w), conducting hydrothermal treatment at 120° C. to 160° C. for 10 min to 30 min, cooling, conducting filter pressing to obtain the soluble organic matter rich in amino acids and organic salts, and conducting evaporation to dryness to obtain the mixture C; wherein
the mixture C has a chemical oxygen demand (COD) of 8,000 mg/g to 10,000 mg/g of a dry basis, an amino acid content of 80 mg/g to 100 mg/g of the dry basis, and an electrical conductivity of 5 ds/m to 10 ds/m.

17. The preparation method according to claim 11, wherein the pyrolysis is conducted at 600° C. to 800° C. under an inert atmosphere comprising nitrogen or argon as a carrier gas at a gas flow rate of 100 mL/min to 200 mL/min for 30 min to 60 min; a pyrolysis program starts from a room temperature by heating at 8° C./min to 20° C./min, and then terminates by cooling gradually to the room temperature at 10° C./min to 30° C./min; and
the biochar D has a specific surface area of 800 m²/g to 1,200 m²/g, comprises oxides of iron, magnesium, and aluminum, and has an iron content of 50 mg/g to 80 mg/g, an aluminum content of 50 mg/g to 80 mg/g, and a magnesium content of 10 mg/g to 20 mg/g.

18. The preparation method according to claim 11, wherein the stabilized product A, the humus B, the mixture C, and the biochar D are mixed at a mass ratio of (5-10):1:1:1.

19. A soil amendment prepared by the preparation method according to claim 11.

20. The method according to claim 2, wherein an auxiliary material with a mass ratio of 20% to 40% of a dry weight of the sludge is added during the aerobic composting, and the auxiliary material is selected from the group consisting of straw and rice husk; and the aerobic composting is conducted at 50° C. to 60° C. or 70° C. to 80° C. for 20 d to 30 d.
